(19) United States
(12) Patent Application Publication
(10) Pub. No.: US 2015/0288812 A1
(43) Pub. Date: Oct. 8, 2015

(54) MOBILE COMPUTING DEVICES WITH PARENTAL CONTROL

(71) Applicant: Shao-Chieh TING, New Taipei City (TW)

(72) Inventor: Shao-Chieh TING, New Taipei City (TW)

(21) Appl. No.: 14/243,077

(22) Filed: Apr. 2, 2014

(51) Int. Cl. H04M 3/42; G11B 20/00; H04W 4/02

(52) U.S. Cl. CPC H04M 3/42; H04W 4/02; G11B 20/00137; G11B 20/00159

(57) ABSTRACT

Methods, systems, and apparatus, including computer programs encoded on a computer storage medium, for providing parental control in viewing a mobile computing device. According to one implementation, a method includes receiving data for determining a distance between a user of a mobile computing device and a viewing screen of the mobile computing device; determining, by the mobile computing device, the distance between the user and the viewing screen of the mobile computing device; based on the distance, specifying a duration for which the user is authorized to view the mobile computing device; and disabling the viewing screen of the mobile computing device upon an expiration of the duration.

### BACKGROUND OF THE INVENTION

(a) Field of the Invention

This specification generally relates to parental control of mobile computing devices.

(b) Description of the Prior Art

A distance between a user and a monitor of a mobile computing device may be monitored by the mobile computing device. Viewing time of the mobile computing device may be controlled after the distance satisfies a threshold.

### SUMMARY OF THE INVENTION

According to one innovative aspect of the subject matter described in this specification, a mobile computing device may include a parental control feature. The mobile computing device may monitor a child's usage of the mobile computing device including distance and time. If the usage does not satisfy a predetermined threshold, the viewing of the mobile computing device may be stopped automatically.

Another innovative aspect of the subject matter described in this specification, a method includes receiving data for determining a distance between a user of a mobile computing device and a viewing screen of the mobile computing device, determining, by the mobile computing device, the distance between the user and the viewing screen of the mobile computing device, based on the distance, specifying a duration for which the user is authorized to view the mobile computing device, and disabling the viewing screen of the mobile computing device upon an expiration of the duration.

Other embodiments of these aspects include corresponding systems, apparatus, and computer programs, configured to perform the actions of the methods, encoded on computer storage devices.

These and other embodiments may each optionally include one or more of the following features. For instance, receiving data for determining a distance between a user and a viewing screen of the mobile computing device may include receiving data indicating the distance between the user and the viewing screen from an infrared sensor of the mobile computing device.

Receiving data for determining a distance between a user and a viewing screen of the mobile computing device may include receiving image data from a camera of the mobile computing device, the image data including the user and a reference object. Determining the distance between the user and the viewing screen may include determining a reference distance between the reference object and the viewing screen, and based on the reference distance, determining the distance between the user and the viewing screen.

Receiving data for determining a distance between a user and a viewing screen of the mobile computing device may include receiving data from a wearable computing device worn by the user. Determining the distance between the user and the viewing screen may include obtaining a position of the wearable computing device, obtaining a position of the mobile computing device, and determining the distance between the user and the viewing screen based on the position of the wearable computing device and the position of the mobile computing device.

Receiving data indicating a distance between a user and a viewing screen of the mobile computing device may include receiving data from a short range communications transmitter of the wearable device.

Receiving data for determining a distance between a user and a viewing screen of the mobile computing device may include receiving image data from a camera of a third-party computing device, the image data including the user, the mobile computing device, and a reference object. Determining the distance between the user and the viewing screen may include determining a first reference distance between the reference object and the user, determining a second reference distance between the reference object and the mobile computing device, and based on the first and the second reference distances, determining the distance between the user and the viewing screen.

Based on the distance, specifying a duration for which the user is authorized to view the mobile computing device may include determining that the distance does not satisfy a threshold, and in response to determining that the distance does not satisfy the threshold, specifying the duration to be expired.

Based on the distance, specifying a duration for which the user is authorized to view the mobile computing device may include determining that the distance satisfies a threshold, and in response to determining that the distance satisfies the threshold, specifying the duration to be a predetermined value.

Based on the distance, specifying a duration for which the user is authorized to view the mobile computing device may include monitoring, by the mobile computing device, an accumulated usage representing a duration that the user has viewed the viewing screen, wherein the viewing screen is enabled only when the distance satisfies a threshold, determining that the usage duration exceeds a predetermined value, and based on determining that the usage duration exceeds the predetermined value, specifying a remaining duration for which the user is authorized to view the mobile computing device.

The method may include displaying the duration on the viewing screen of the mobile computing device, and updating the duration on the viewing screen while the user continues to view the viewing screen.

Specifying a duration for which the user is authorized to view the mobile computing device may include receiving data configuring a viewing duration, receiving data configuring a rewarding duration, and receiving data configuring a disabling duration.

Advantageous implementations may include one or more of the following features. A child is encouraged to keep a safe distance from the monitor of the mobile computing device when viewing content displayed on the monitor. A parent or a guardian has the flexibility to configure parameters such as viewing distance or viewing time according to the child's situation.

The details of one or more implementations are set forth in the accompanying drawings and the description below. Other potential features and advantages will become apparent from the description, the drawings, and the claims.

### BRIEF DESCRIPTION OF THE DRAWINGS

FIG. 1 is a block diagram of an example mobile computing device.

FIG. 2 is a flow chart illustrating an example process for monitoring a child's usage of a mobile computing device.

FIG. 3 is a flow chart illustrating an example process for configuring a child's usage of a mobile computing device.

### DETAILED DESCRIPTION OF THE PREFERRED EMBODIMENTS

With the widespread of mobile computing devices around the world, more and more parents purchase mobile computing devices for their children for learning or entertainment purchases. A mobile computing device may include a tablet computer, a mobile telephone, or a personal digital assistant (PDA), to name just a few. A mobile computing device may often play the role of a nanny for the children. However, children may lack self-control, and may not be able to self-regulate the usage time as well as the viewing distance to the mobile computing device. A mobile computing device that can help regulate the viewing distance between children and the mobile computing device, and improve children's viewing behavior is desirable.

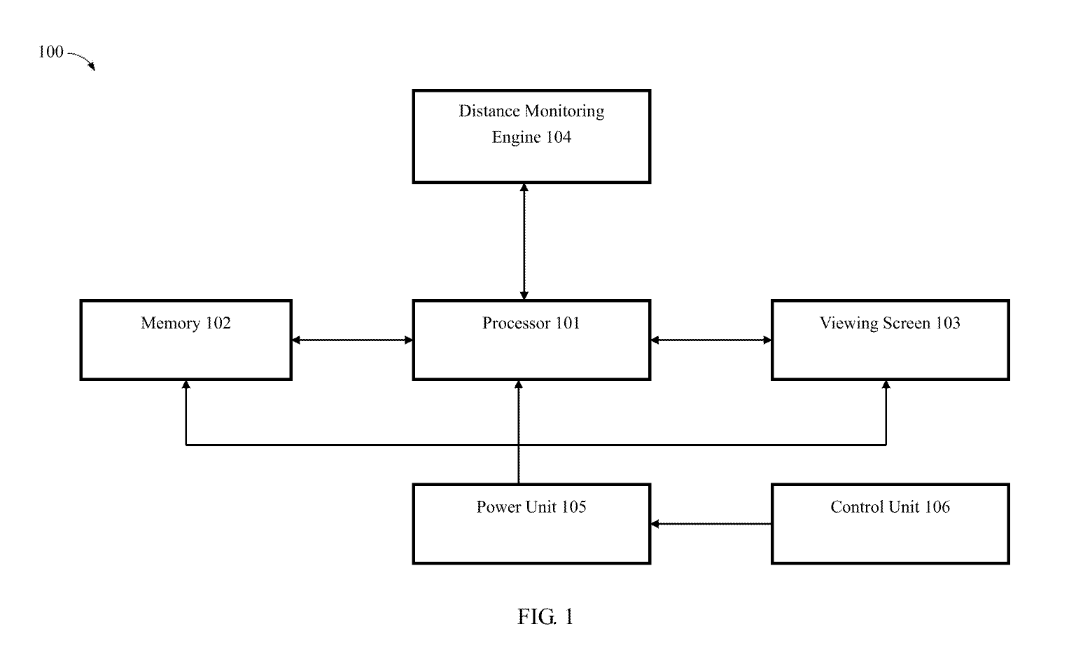

FIG. 1 is a block diagram of mobile computing devices 100 that may be used to implement the systems and methods described in this document, as either a client or as a server or plurality of servers. Computing device 100 is intended to represent various forms of mobile devices, such as tablet computers, personal digital assistants, smartphones, and other similar computing devices.

A mobile computing device 100 includes a processor 101, memory 102, a viewing screen 103, a distance monitoring engine 104, a power unit 105, and a control unit 106.

The processor 101 can process instructions for execution within the computing device 100, including instructions stored in the memory 102 to display graphical information for a GUI (Graphical User Interface) on an external input/output device, such as the viewing screen 103. In other implementations, multiple processors and/or multiple buses may be used, as appropriate, along with multiple memories and types of memory.

The memory 102 stores information within the computing device 100. In one implementation, the memory 102 is a volatile memory unit or units. In another implementation, the memory 102 is a non-volatile memory unit or units. The memory 102 may also be another form of computer-readable medium, such as a magnetic or optical disk.

The viewing screen 103 may be, for example, a TFT (Thin-Film-Transistor Liquid Crystal Display) display, or an LED (Light Emitting Diode) display, or an LCD (Liquid Crystal Display) display, or an OLED (Organic Light Emitting Diode) display, or other appropriate display technology.

In general, the distance monitoring engine 104 determines a distance between the mobile computing device 100 and the user. As used in this specification, an “engine” (or “software engine”) refers to a software implemented input/output system that provides an output that is different from the input. An engine can be an encoded block of functionality, such as a library, a platform, a Software Development Kit (“SDK”), or an object.

The power unit 105 controls the power supplied to the processor 101, the memory 102, and the viewing screen 103.

The control unit 106 is configured to send signals to the power unit 105 to control the power supplied to the processor 101, the memory 102, and the viewing screen 103. For example, the control unit 106 may send control signals to the power unit 105 to put the mobile computing device 100 into a low-power mode, a safe mode, or disabled mode, so the user cannot access the viewing screen 103 until a distance between the user and the viewing screen 103 satisfies a threshold. As another example, the control unit 106 may send control signals to the power unit 105 to disable the viewing screen 103, so the user cannot access the viewing screen 103 until a distance between the user and the viewing screen 103 satisfies a threshold.

The mobile computing device 100 may communicate wirelessly through a communication interface, which may include digital signal processing circuitry where necessary. A communication interface may provide for communications under various modes or protocols, such as GSM (Global System for Mobile Communications) voice calls, SMS (Short Message Service), EMS (Enhanced Message Service), or MMS (Multimedia Messaging Service) messaging, CDMA (Code Division Multiple Access), TDMA (Time Division Multiple Access), PDC (Personal Digital Cellular), WCDMA (Wide band Code Division Multiple Access), CDMA2000 (Code Division Multiple Access 2000), or GPRS (General Packet Radio Service), among others. Such communication may occur, for example, through a radio-frequency transceiver. In addition, short-range communication may occur, such as using a Bluetooth, WiFi, or other such transceiver (not shown). In addition, GPS (Global Positioning System) receiver module may provide additional navigation- and location-related wireless data to device, which may be used as appropriate by applications running on the mobile computing device 100.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

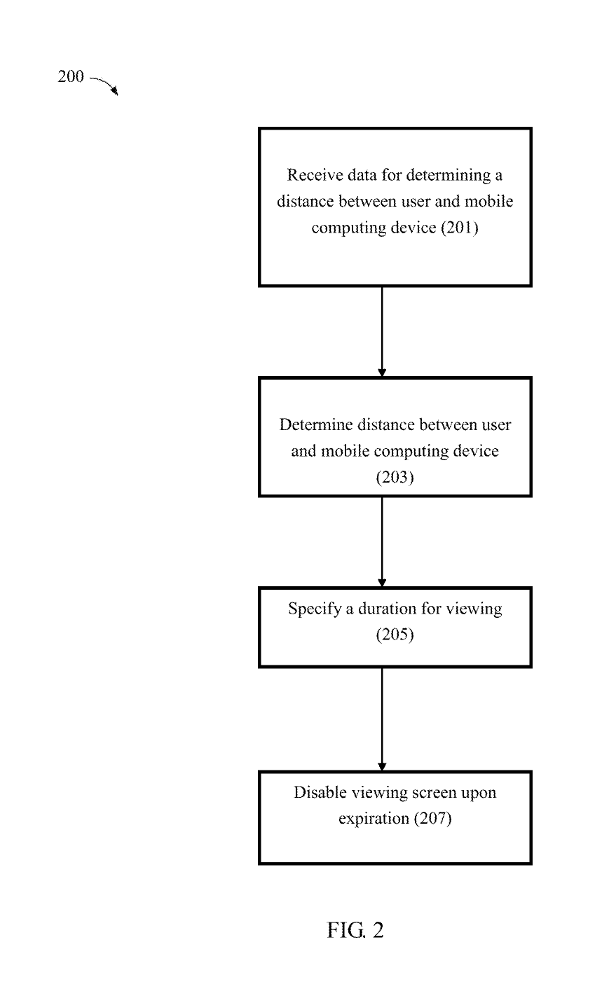

FIG. 2 is a flow chart illustrating an example process 200 for monitoring a child's usage of a mobile computing device. The process 200 can be performed by, for example, the mobile computing device 100 in FIG. 1.

The system receives data for determining a distance between a user of a mobile computing device and a viewing screen of the mobile computing device (201). The system determines, by the mobile computing device, the distance between the user and the viewing screen of the mobile computing device (203).

In some implementations, the distance monitoring engine 104 may determine a distance between the mobile computing device 100 and the user using an infrared sensor of the mobile computing device 100. For example, the infrared sensor may provide a short range measurement of a distance between the mobile computing device 100 and the user.

In some implementations, the distance monitoring engine 104 may determine a distance between the mobile computing device 100 and the user using a camera of the mobile computing device 100. For example, the camera may capture image data that include the user and a reference object. The distance monitoring engine 104 may use the image data to determine a reference distance between the reference object and the viewing screen, and based on the reference distance, to determine the distance between the user and the viewing screen.

In some implementations, the distance monitoring engine 104 may determine a distance between the mobile computing device 100 and the user using a wearable computing device worn by the user. A wearable computing device can be a pair of glasses, a watch, or any wearable computing devices that include one or more processors for executing computer programs. The mobile computing device 100 may obtain a position of the wearable computing device using GPS data or similar technologies. The mobile computing device 100 may then obtain a position of the mobile computing device 100. The distance monitoring engine 104 may then determine the distance between the user and the viewing screen based on the position of the wearable computing device and the position of the mobile computing device. In some implementations, data is received from a short range communications transmitter of the wearable device.

In some implementations, the distance monitoring engine 104 may determine a distance between the mobile computing device 100 and the user using image data from a camera of a third-party computing device, where the image data may include the user, the mobile computing device, and a reference object. The mobile computing device 100 may determine a first reference distance between the reference object and the user. The mobile computing device 100 may then determine a second reference distance between the reference object and the mobile computing device. The distance monitoring engine 104 may then determine the distance between the user and the viewing screen based on the first and the second reference distances.

Based on the distance, the system specifies a duration for which the user is authorized to view the mobile computing device (205). The system disables the viewing screen of the mobile computing device upon an expiration of the duration (207).

In some implementations, the system may determine that the distance does not satisfy a threshold, and in response to determining that the distance does not satisfy the threshold, the system may specify the duration to be expired. For example, if the child user is too close to the viewing screen, the duration is expired, and the viewing screen is disabled either through disabling the viewing screen, or the mobile computing device may enter a sleep mode.

In some implementations, the system may determine that the distance satisfies a threshold. In response to determining that the distance satisfies the threshold, the system may specify the duration to be a predetermined value. For example, the predetermined value can be a time duration that is entered by a parent of the child user before the child user has access to the mobile computing device.

In some implementations, the system may monitor an accumulated usage representing a duration that the user has viewed the viewing screen, the viewing screen is enabled only when the distance satisfies a threshold. The system may determine that the usage duration exceeds a predetermined value. Based on determining that the current usage duration exceeds the predetermined value, the system may specify a remaining duration for which the user is authorized to view the mobile computing device. For example, once a child user has kept the viewing screen far enough in distance for a predetermined amount of time (e.g., ten minutes), the system may calculate a remaining duration for which the child user may continue to view the viewing screen, provided that the viewing distance satisfies a threshold.

In some implementations, the system may display the duration on the viewing screen of the mobile computing device. The system may update the duration on the viewing screen while the user continues to view the viewing screen, such that the user knows how much viewing time is remained. For example, by providing the remaining time to a child user, the child user may learn to respect the viewing time.

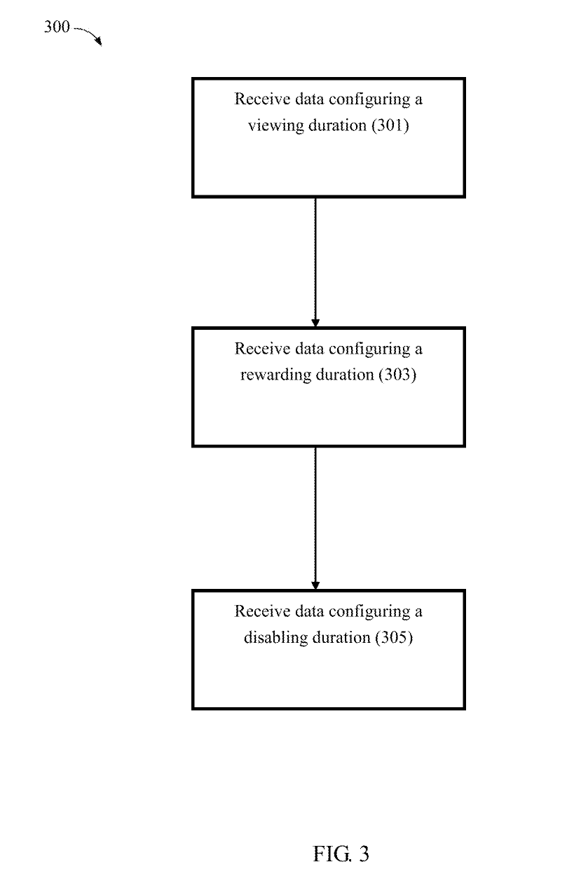

FIG. 3 is a flow chart illustrating an example process 300 for configuring a child's usage of a mobile computing device. The process 300 can be performed by, for example, the mobile computing device 100 in FIG. 1. In some implementations, the parameters below can be manually entered by a parent or a control person of the mobile computing device. In some implementations, the parameters below can be preset values of the mobile computing device. In some implementations, the parameters below can be automatically adjusted by the mobile computing device based on a child's behavior.

The system receives data configuring a viewing duration for viewing content on the mobile computing device (301). For example, the duration may indicate how many hours, minutes, seconds, or a combination thereof that a user may view the mobile computing device if a viewing distance satisfies a threshold.

The system receives data configuring a reward duration for viewing (303). For example, the duration may indicate how many hours, minutes, seconds, or a combination thereof that a user may view the mobile computing device if a reward condition is satisfied. As an example, a reward condition may be satisfied if a child user has kept a safe distance from the viewing screen for a predetermined period of time. In some implementations, the reward duration may be added on top of the viewing duration.

The system receives data configuring a disabling duration for a next viewing (303). For example, the duration may indicate how many hours, minutes, seconds, or a combination thereof that a user may not view the mobile computing device after a viewing duration has expired.

A number of implementations have been described. Nevertheless, it will be understood that various modifications may be made without departing from the spirit and scope of the disclosure. For example, various forms of the flows shown above may be used, with steps re-ordered, added, or removed.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer-readable medium for execution by, or to control the operation of, data processing apparatus. The computer readable-medium may be a machine-readable storage device, a machine-readable storage substrate, a memory device, a composition of matter affecting a machine-readable propagated signal, or a combination of one or more of them. The computer-readable medium may be a non-transitory computer-readable medium. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the techniques disclosed, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. A computer-implemented method comprising steps of:
a) receiving data for determining a distance between a user of a mobile computing device and a viewing screen of the mobile computing device;
b) determining, by the mobile computing device, the distance between the user and the viewing screen of the mobile computing device;
c) based on the distance, specifying a duration such that the user is authorized to view the mobile computing device; and
d) disabling the viewing screen of the mobile computing device upon an expiration of the duration.

2. The computer-implemented method according to claim 1, wherein receiving data for determining the distance between the user and the viewing screen of the mobile computing device comprises receiving, by an infrared sensor of the mobile computing device, data indicating the distance between the user and the viewing screen.

3. The computer-implemented method according to of claim 1,
wherein receiving data for determining a distance between the user and the viewing screen of the mobile computing device comprises receiving image data from a camera of the mobile computing device, the image data including the user and a reference object, and
wherein determining the distance between the user and the viewing screen comprising steps of:
a) determining a reference distance between the reference object and the viewing screen; and
b) based on the reference distance, determining the distance between the user and the viewing screen.

4. The computer-implemented method according to claim 1,
wherein receiving data for determining a distance between the user and the viewing screen of the mobile computing device comprises receiving data from a wearable computing device worn by the user, and
wherein determining the distance between the user and the viewing screen comprising steps of:
a) obtaining a position of the wearable computing device;
b) obtaining a position of the mobile computing device; and
c) determining the distance between the user and the viewing screen based on the position of the wearable computing device and the position of the mobile computing device.

5. The computer-implemented method according to claim 4, wherein receiving data indicating a distance between the user and the viewing screen of the mobile computing device comprises receiving data from a short range communications transmitter of the wearable device.

6. The computer-implemented method according to claim 1,
wherein receiving data for determining a distance between the user and the viewing screen of the mobile computing device comprises receiving image data from a camera of a third-party computing device, the image data including the user, the mobile computing device, and a reference object, and
wherein determining the distance between the user and the viewing screen comprising steps of:
a) determining a first reference distance between the reference object and the user;
b) determining a second reference distance between the reference object and the mobile computing device; and
c) based on the first and the second reference distances, determining the distance between the user and the viewing screen.

7. The computer-implemented method according to claim 1, wherein based on the distance, specifying a duration for which the user is authorized to view the mobile computing device comprising steps of:
a) determining that the distance does not satisfy a threshold; and
b) in response to determining that the distance does not satisfy the threshold, specifying the duration to be expired.

8. The computer-implemented method according to claim 1, wherein based on the distance, specifying a duration for which the user is authorized to view the mobile computing device comprising steps of:
a) determining that the distance satisfies a threshold; and
b) in response to determining that the distance satisfies the threshold, specifying the duration to be a predetermined value.

9. The computer-implemented method according to claim 1, wherein based on the distance, specifying a duration for which the user is authorized to view the mobile computing device comprising steps of:
a) monitoring, by the mobile computing device, an accumulated usage representing a duration that the user has viewed the viewing screen, wherein the viewing screen is enabled only when the distance satisfies a threshold;
b) determining that the usage duration exceeds a predetermined value; and
c) based on determining that the usage duration exceeds the predetermined value, specifying a remaining duration for which the user is authorized to view the mobile computing device.

10. The computer-implemented method according to claim 1, further comprising steps of:
a) displaying the duration on the viewing screen of the mobile computing device; and
b) updating the duration on the viewing screen while the user continues to view the viewing screen.

11. The computer-implemented method according to claim 1, wherein specifying a duration for which the user is authorized to view the mobile computing device comprising steps of:
a) receiving data configuring a viewing duration;
b) receiving data configuring a rewarding duration; and
c) receiving data configuring a disabling duration.

12. A computer-implemented system comprising:
one or more processors;
a viewing screen for displaying content to a user; and
a computer-readable medium having stored thereon instructions that, when executed by the one or more computers, cause the one or more computers to perform operations comprising:
receiving data for determining a distance between a user of a mobile computing device and a viewing screen of the mobile computing device;
determining, by the mobile computing device, the distance between the user and the viewing screen of the mobile computing device;
based on the distance, specifying a duration for which the user is authorized to view the mobile computing device; and
disabling the viewing screen of the mobile computing device upon an expiration of the duration.

13. The computer-implemented system according to claim 12, wherein based on the distance, specifying a duration for which the user is authorized to view the mobile computing device comprises:
determining that the distance does not satisfy a threshold; and
in response to determining that the distance does not satisfy the threshold, specifying the duration to be expired.

14. The computer-implemented system according to claim 12, wherein based on the distance, specifying a duration for which the user is authorized to view the mobile computing device comprises:
determining that the distance satisfies a threshold; and
in response to determining that the distance satisfies the threshold, specifying the duration to be a predetermined value.

15. The computer-implemented system according to claim 12, wherein based on the distance, specifying a duration for which the user is authorized to view the mobile computing device comprises:
monitoring, by the mobile computing device, an accumulated usage representing a duration that the user has viewed the viewing screen, wherein the viewing screen is enabled only when the distance satisfies a threshold;
determining that the usage duration exceeds a predetermined value; and based on determining that the usage duration exceeds the predetermined value, specifying a remaining duration for which the user is authorized to view the mobile computing device.

16. The computer-implemented system according to claim 12,
wherein receiving data for determining a distance between a user and a viewing screen of the mobile computing device comprises receiving data from a wearable computing device worn by the user, and
wherein determining the distance between the user and the viewing screen comprises:
obtaining a position of the wearable computing device;
obtaining a position of the mobile computing device; and
determining the distance between the user and the viewing screen based on the position of the wearable computing device and the position of the mobile computing device.

17. A computer-readable medium having stored thereon instructions, which, when executed by a computer, cause the computer to perform operations comprising:
receiving data for determining a distance between a user of a mobile computing device and a viewing screen of the mobile computing device;
determining, by the mobile computing device, the distance between the user and the viewing screen of the mobile computing device;
based on the distance, specifying a duration for which the user is authorized to view the mobile computing device; and
disabling the viewing screen of the mobile computing device upon an expiration of the duration.

18. The computer-readable medium according to claim 17, wherein based on the distance, specifying a duration for which the user is authorized to view the mobile computing device comprises:
determining that the distance does not satisfy a threshold; and
in response to determining that the distance does not satisfy the threshold, specifying the duration to be expired.

19. The computer-readable medium according to claim 17, wherein based on the distance, specifying a duration for which the user is authorized to view the mobile computing device comprises:
determining that the distance satisfies a threshold; and
in response to determining that the distance satisfies the threshold, specifying the duration to be a predetermined value.

20. The computer-readable medium according to claim 17, wherein based on the distance, specifying a duration for which the user is authorized to view the mobile computing device comprises:
monitoring, by the mobile computing device, an accumulated usage representing a duration that the user has viewed the viewing screen, wherein the viewing screen is enabled only when the distance satisfies a threshold;
determining that the usage duration exceeds a predetermined value; and based on determining that the usage duration exceeds the predetermined value, specifying a remaining duration for which the user is authorized to view the mobile computing device.
